(19) United States
(12) Patent Application Publication
(10) Pub. No.: US 2025/0042778 A1
(43) Pub. Date: Feb. 6, 2025

(54) RO PURIFIER WITH PROVISION TO DISPENSE HOT OR COLD WATER

(71) Applicant: Zhejiang Qinyuan Water Treatment S. T. Co., Ltd., Ningbo City (CN)

(72) Inventors: Junbo GUO, Ningbo (CN); Dong HUANG, Ningbo (CN); Zhaoyang LI, Ningbo (CN); Xiaofei LU, Ningbo (CN); Xiaoping ZHANG, Ningbo (CN)

(73) Assignee: Zhejiang Qinyuan Water Treatment S. T. Co., Ltd., Ningbo City (CN)

(21) Appl. No.: 18/836,289

(22) PCT Filed: Feb. 16, 2023
(86) PCT No.: PCT/EP2023/053830

§ 371 Date: Aug. 6, 2024

(30) Foreign Application Priority Data
Feb. 17, 2022 (WO) PCT/CN2022/076592
Mar. 28, 2022 (EP) 22164823.1

(51) Int. Cl. C02F 1/44

(52) U.S. Cl. CPC C02F 1/441; C02F 2209/006; C02F 2209/02; C02F 2301/046

(57) ABSTRACT

The invention relates to RO water purifier (100) with provision for dispensing hot or cold water. The device has a user-interface through which a user can choose how hot the purified water should be. The RO water purifier (100) comprises a compartment (9) for storage of pre-heated or pre-cooled purified water. The compartment comprises an inlet for return of any undispensed purified hot, cold, or ambient water to flow back from the user-interface. The compartment has an outlet for pre-heated or pre-cooled purified water to flow out into a device (8) for heating or cooling it further as desired by the user. The device for heating or cooling the purified ambient water is configured to heat the water to 80 to 95° C. or alternatively, is configured to cool it to 15 to 5° C., and wherein in said e compartment said pre-heated water is stored at 40 to 75° C. and when it is pre, cooled it is stored at 10 to 20° C., and wherein temperature of said purified ambient water is 25 to 40° C.

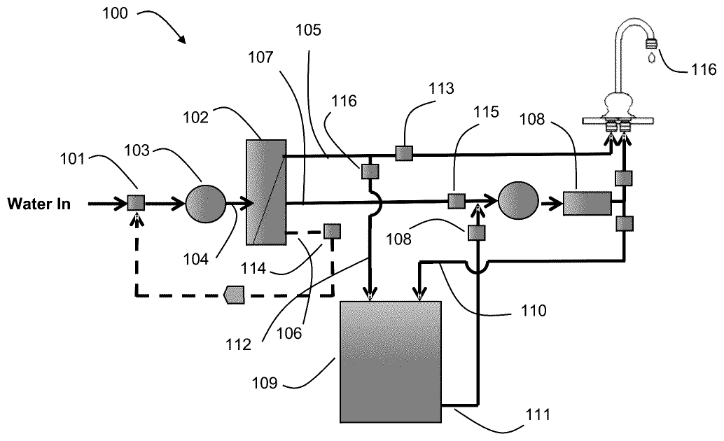

### FIELD OF THE INVENTION

The present invention relates to RO water purifier with provision for dispensing hot or cold water.

### BACKGROUND OF THE INVENTION

RO based water purification devices often contain some additional functions. One such function is the provision to dispense hot water. An alternative is to dispense chilled water. Some purifiers have built-in provision to store purified hot or cold water that can be readily dispensed. Some other devices are tankless.

The more popular ones are equipped with an inline mechanism for heating where storage of purified hot or cold water is not necessary.

However, the in-line or under-the-sink (also known as UTS) devices often need to be able to dispense water as hot as 90° C. In such devices, the flow rate of inlet water is generally in the range of 600 to 800 ml/minute.

CN208355240 U (Zhejiang Qinyuan) discloses a UTS device containing inlet and outlet lines and plurality of solenoid valves. The pure water outlet pipe is equipped with a pure water solenoid valve; it also includes a heating water pipe connected to the pure water outlet pipe. The heating water pipe is equipped with a hot water solenoid valve and a heating body. There is a pressure reducing valve at the water outlet, and the raw water enters the water purifier through the pressure reducing valve of the device to ensure a constant inlet pressure. There is a control module to regulate the flow of water to meet the diverse needs of a user. Any excess purified heated water is led back into the inlet stream where it needs to go through the entire process of RO filtration all over again before it is fit for consumption.

CN113830950 A (Dreame Innovation) discloses an RO water purifier comprising a provision for storage of pre-heated water which is pre-heated by heating elements placed therein. The device comprises a water tank (6) and a heat tank (9). The excess/undispensed hot water returns to the heat tank (9), not the water tank (6).

KR20140071834 A (Cuckoo Electronics, 2014) discloses a water treatment device having RO membrane filter. The device has a first storage tank and a second storage tank respectively storing the water filtered by the filter unit at different temperatures; a circulation passage connected to circulate the water discharged from the first storage tank to the first storage tank via the second storage tank. The first storage tank includes an upper space for storing room temperature water and a lower space for storing cold water; The circulation passage includes a cold water intake line connecting the lower space and a cold water intake valve for supplying cold water to the user, and a hot water intake line for supplying hot water to the second storage tank and the user. After sequentially passing through a hot water intake line connecting between valves, the hot water may flow into the second storage tank, and the water in the second storage tank may be discharged and flowed back into the first storage tank.

If a user wants a cup of hot water, example from 85 to 95° C., then the heating element present in the device needs to operate at high power. Any such device needs to be safe for use at all times and flow-rate needs to be reasonably high, example, 1.5 to 2.5 litres/minute.

If a user wants very hot water like at 94° C., or alternatively very cold water at e.g., 5° C., then flow rate could become a limiting factor because the heating or cooling component needs to operate at very high power to be able to do that.

It is an object of the invention to provide a high-flux RO water purifier in which flow rate of hot (or alternatively cold) water is maintained constant and high. Yet another object of the invention is to better utilize the purified hot water. Instead of hot water, the device may be configured to dispense cold water, e.g., chilled water.

We have provided a simple solution to the problem which lies in the provision of a compartment for storage of pre-heated or pre-cooled purified water as further disclosed hereunder.

### SUMMARY OF THE INVENTION

In accordance with the invention, disclosed is an RO water purifier (100) comprising:
(i) an inlet for raw water comprising a pressure reducing valve (101);
(ii) a booster pump (103);
(iii) a RO membrane (102) configured to work under an operating pressure,
(iv) a device (108) for heating or cooling purified ambient water;
(v) a user-interface for dispensing hot, cold, or ambient purified water; and,
(vi) a Micro Controller Unit (MCU) to control functions of said purifier,
where said purifier comprises a compartment (109) comprising an inlet (110) and an outlet (111), to store pre-heated or pre-cooled purified water,
wherein,
when said purifier (100) is in use, any undispensed purified hot, cold, or ambient water returns into said compartment (109) through said inlet (110), where it remains pre-heated or pre-cooled, and when a user dispenses water through said User Interface, said pre-heated or pre-cooled purified water flows out of said compartment through said outlet (111) into said device (108) for further heating or cooling it, before being dispensed,
wherein said device (108) for heating or cooling the purified ambient water is configured to heat the water to 80 to 95° C. or alternatively, is configured to cool it to 15 to 5° C., and wherein in said compartment (109) said pre-heated water is stored at 40 to 75° C. and when it is pre-cooled it is stored at 10 to 20° C., and wherein temperature of said purified ambient water is 25 to 40° C.

### DETAILED DESCRIPTION OF THE INVENTION

Flux or water flux is typically expressed as volume per area per unit of time. Flux is used to express the rate at which water permeates a reverse osmosis membrane. Typical units of measurement is litres per square meter per hour (l/m²/hr).

The RO water purifier of the invention comprises an inlet for raw water comprising a pressure reducing valve to reduce pressure if is beyond the operating pressure of a RO membrane placed downstream. The inlet pressure of water varies from country-to-country and region-to-region. The valve reduces pressure of inlet water to preferably bring it in the range of 0.5 to 0.2 MPa and makes the device safer. This pressure may as such be suitable and may be within operating pressure of the RO membrane. This operating pressure may also vary depending on the make and material of construction of the membrane. Accordingly, the range may be wide. In one aspect preferably operating pressure is 0.6 to 1.0 MPa, more preferably 0.6 to 0.8 MPa. In such a case, the pressure reducing valve preferably reduces the pressure of inlet water to 0.2 to 0.3 MPa. When the pressure is so reduced, it is necessary to increase it again so that it is within the operating pressure. The purifier comprises a booster pump to increase the pressure if it is lower than the operating pressure. It is preferred that the operating pressure is 0.5 to 1.0 MPa.

The purifier comprises an RO membrane configured to work under said operating pressure. Reverse osmosis (RO) is a membrane filtration method that removes large molecules and ions from solutions by applying pressure to the solution when it is on one side of a selective membrane. The result is that the solute is retained on the pressurized side of the membrane and the pure solvent is allowed to pass to the other side. To be “selective,” this membrane should not allow large molecules or ions through the pores (holes) but should allow smaller components of the solution (such as water) to pass freely. In the normal osmosis process the solvent naturally moves from an area of low solute concentration, through a membrane, to an area of high solute concentration. The movement of a pure solvent to equalize solute concentrations on each side of a membrane generates osmotic pressure. Applying an external pressure to reverse the natural flow of pure solvent, thus, is reverse osmosis. Reverse osmosis, however, involves a diffusive mechanism so that separation efficiency is dependent on solute concentration, pressure, and water flux rate. Reverse osmosis is most commonly known for its use in drinking water purification from seawater, removing the salt and other substances from the water molecules. RO membranes are commercially available for industrial and domestic use. The RO membranes may be made in a variety of configurations, with the most preferred configuration being the TFC (thin film composite). A preferred RO membrane is FILMTEC™ Membranes Product TW30-1812-50 from The Dow Chemical Company.

It is preferred that the device of the present invention includes a ‘total dissolved solids’ (TDS) measuring means or a Total Dissolved Solids (TDS) sensor positioned on the treated water line, adapted to determine the total dissolved solids adapted to measure TDS of the water flowing out of the treatment unit; and communicating the measured value to the control circuit. The TDS sensor is therefore positioned downstream of the treatment unit and is adapted to measure the TDS of water on the treated water line when the device is in operation.

The term “dissolved solids” refers generally to any minerals, salts, metals, cations or anions that are dissolved in a water sample. Dissolved solids include many of the substances that impair water colour, odor, taste, or overall water quality. Many industries, and the food service industry requires that the water used be held to stringent standards such that the color, odor, or taste of the water does not have any adverse effect on it.

A TDS sensor may be of any type being capable of sensing or measuring the total dissolved solids. A commonly used TDS meter displays the TDS in parts per million (ppm). For example, a TDS reading of 1 ppm would indicate there is 1 milligram of dissolved solids in 1 kilogram of water. It possible to estimate the TDS level by measuring the electrical conductivity (EC) of the water with a meter and converting. A TDS meter may be an EC meter converting an EC reading to represent the TDS in the sample. Some meters can be selected to display either value.

As the amount of water passing through the reverse osmosis membrane is proportional to the pressure of water upstream of the membrane, the booster pump is specially configured upstream of the reverse osmosis membrane of the water purifier. Pure water can be produced only when pressure of the source water is within the operating pressure.

The purifier of the invention comprises an inlet for water, a first outlet for purified ambient water, a second outlet for recirculation of excess purified ambient water back to said inlet and a third outlet leading to a device for heating or cooling said purified ambient water.

The device for heating or cooling the purified ambient water is configured to heat the water to 80 to 95° C. or alternatively, is configured to cool it to 15 to 5° C. Preferably, this device for heating or cooling the purified ambient water is also provided with a temperature sensor connected to the control module. The temperature sensor detects the temperature signal of the water temperature in the pipe and transmits it to the control module. The control module controls this device for heating or cooling the purified ambient water to adjust the heating or cooling temperature according to the received temperature signal.

According to the requirements of the outlet water temperature, the built-in flow regulating valve performs flow distribution and heating power adjustment to meet the hot or cold-water demand of different temperatures.

The device comprises a user-interface for dispensing hot, cold, or ambient purified water. Preferably the user interface comprises plurality of buttons for providing options to dispense hot, cold, or ambient purified water at temperature ranging from 5 to 95° C.

There is a Micro Controller Unit (MCU) to control functions of the purifier. The control circuit can be either manually or automatically controlled. Alternatively, there is a PLC (Programmable Controller Logic) for the same function.

The MCU is configured to store at least two threshold TDS values X_{A} and X_{B}, wherein X_{A} is a higher TDS value than X_{B}; and to drain water from reject line of the RO membrane through the drain line, when TDS value sensed is higher than X_{A}, and alternatively when the sensed value of TDS is less than X_{B} then direct water from the reject line into the recycle line.

It is further preferred that the MCU is further configured to choose from the options selected from the group:
a) water from the reject line only flows through the drain line when sensed TDS is higher than X_{A}; or
b) water from the reject line flows through the first recycle line and a second drain line when sensed TDS is less than X_{B}; or
c) when water from the reject line flows through the second recycle line and the third drain line when sensed TDS is higher than X_{B} and less than X_{A}; when the device is in operation.

Preferably the MCU comprises a memory. It preferably, includes a simple feedback circuitry or a microprocessor. Preferably the microprocessor control system is Micro Controller Unit (MCU) system capable of monitoring the resistance, impedance, or conductance of the electrodes to enable the adjusting of power output to the electrodes via a connection. Preferably the microprocessor system is associated with software adapted to drive the microprocessor control system.

Alternatively, the MCU may be an analogue system utilising comparator or a digital system without a microprocessor.

Preferably there is a flow rate and/or pressure detecting means adapted to detect the flow or pressure of water entering the device to switch the system on or off in the presence or absence of the flow of water in the device. It is preferred that the flow and/or pressure detecting means can be associated with a timer adapted also to switch the device on and off.

Preferably there is a flow control means for controlling the rate of flow of liquid through the device. For example, the flow control unit may be connected to one or more pumps and/or one or more valves controllable to vary the flow of the water through the device.

Preferably the MCU includes a constant current circuitry which are well known to a person skilled in the art, any known constant current circuitry may be used for the purpose which measures and/or stores the TDS values and compare the stored threshold TDS values with the real-time sensed TDS values.

The MCU stores a threshold value of TDS and compares with the real-time TDS data sensed by TDS sensor, with the stored threshold TDS value. If the sensed TDS value at a given time is higher than the threshold TDS value X_{A}, then the water from the reject water line is drained into the drain line and alternately when the sensed value of TDS is less than X_{B} then direct water from the reject line into the first recycle line, more preferably, when the second recycle line is present and the sensed TDS value is less than X_{A} and higher than X_{B}, the water is directed into the second recycle line.

It is also preferable that the MCU controls the mechanical unit such as a pump. Through the control module, the water discharge of the entire device is intelligently controlled to meet the diversified needs of users. The MCU controls the electric regulating valve to adjust the flow according to the received flow value signal.

The purifier of the invention comprises a compartment comprising an inlet and an outlet, for storage of pre-heated or pre-cooled purified water.

The pre-heated water is stored at 40 to 75° C. and said pre-cooled water is stored at 10 to 20° C. More preferably the temperature of pre-heated water is 65 to 80° C. The temperature of said purified ambient water is 25 to 40° C. Further preferably the compartment comprises a further inlet for inflow of purified ambient water from the RO membrane. The compartment could be of any suitable size and shape so long it is fit for the purpose. It is preferred that the compartment is equipped to hold from 1.5 to 3 litres of water. Preferably it is made of stainless steel but it could also be made of any other suitable material.

This compartment comprises an inlet for undispensed purified hot, cold, or ambient water flowing back or returning from said user-interface; and an outlet for said pre-heated or pre-cooled purified water to flow into said device for further heating or cooling it.

In the water purifier of the invention, it is preferred that:
(a) said first outlet is provided with an ambient water solenoid valve (113);
(b) said second outlet is provided with a recirculation solenoid valve (114);
(c) said third outlet is provided with a further solenoid valve (115); and,
(d) said further inlet is provided with an ambient water solenoid valve (116).

Preferably the purifier of the invention comprises a double-outlet faucet, one of which is connected to the purified water outlet pipe, and the other is connected to the heating or cooling water pipe. Through the double faucet, the hot, cold and ambient water are discharged through independent water channels, which do not affect each other.

### FIGURES

### Brief Description of the FIGURE

The FIGURE shows a flow-diagram of an embodiment of the purifier of the invention.

### DETAILED DESCRIPTION OF THE FIGURE

Seen here is a flow-diagram of an embodiment of the RO water purifier (100) of the invention. The purifier comprises an inlet (Water In) for entry of raw water which means tap water. The pressure reducing valve (101) reduces pressure if is beyond or more than the operating pressure of the RO membrane (102) placed downstream. The purifier has a booster pump (103) to increase the pressure if it is lower than the operating pressure. The RO membrane (102) is configured to work under the operating pressure. Coming into the membrane is an inlet (104) for water; this means the pressurized water. The membrane is provided with a first outlet (105) for purified ambient water and a second outlet (106) for recirculation of excess purified ambient water back to the inlet for raw water, and a third outlet (107). The third outlet (107) leads to a device (108) for heating or cooling the purified ambient water. The first outlet (105) is provided with an ambient water solenoid valve (113). The second outlet (106) is provided with a recirculation solenoid valve (114). The third outlet (107) is provided with a further solenoid valve (115); and the further inlet (112) is provided with an ambient water solenoid valve (116).

The purifier has a user-interface (UI) for dispensing hot, cold, or ambient purified water. The UI is not shown in the FIGURE. The purifier (100) further has a Micro Controller Unit (MCU) to control its functions. The MCU is also not shown in the FIGURE.

Seen here is a compartment (109) for storage of pre-heated or pre-cooled purified water. The compartment comprises an inlet (110) for purified hot, cold, or ambient water flowing back or returning from said user-interface where it remains pre-heated or pre-cooled. The compartment (100) also has an outlet (111) for the pre-heated or pre-cooled purified water to flow into the device (108) for heating or cooling it further. The device (108) for heating or cooling the purified ambient water is configured to heat the water preferably to 80 to 95° C. Alternatively, it can be configured to cool it to preferably 15 to 5° C. The compartment also has a further inlet (112) for inflow of purified ambient water from the RO membrane (102). This ambient water does not flow back from the User Interface. High flux hot water ranging from e.g., 80° C. to 94° C. can be dispensed when preheated water is supplied by compartment (109), and high flux treated ambient water can be obtained directly from the RO membrane (102).

Seen here also is a double-outlet faucet (116) internally in fluid connection with purified ambient water as well as hot or cold (as applicable) purified water.

The purifier may be installed under the sink in a kitchen. The inlet for raw water is connected to municipal tap water.

After connecting, the tap water source is activated and the purifier as such is connected to the power source, and the begins to work. If the user operates a hot water button on the user interface, the device (108) gets activated and starts heating the water as per the settings. The temperature signal is sent to the MCU and the module 115 controls all the necessary functions of the purifier according to the water flow requirement to ensure the water flow, and the device (108) to adjust the temperature to the required temperature value. The required hot water is supplied to the user through the double outlet faucet (117).

The invention will now be explained in detail with the following non-limiting example.

### EXAMPLES

### Example 1

Table 1 contains information about variety of technical and functional parameters concerning the RO water purifier of the invention (Refer: Fig). At first the purifier is operated without feeding water from the container. The effect thereof on flow rate can be seen in Table 2.

TABLE 1

| | | |
|---|---|---|
| Power: P | 2100 | Watt |
| Voltage: U | 220 | V |
| Target temperature | 94° | C. |
| Flux of hot water | 2000 | ml/minute |

TABLE 2

| Purified water/° C. | Flow rate/Flux (ml/minute) |
|---|---|
| 25 | 2000 |
| 30 | 2000 |
| 35 | 2000 |
| 40 | 1940 |
| 45 | 1455 |
| 50 | 1164 |
| 55 | 970 |
| 60 | 831 |
| 65 | 728 |
| 70 | 647 |
| 75 | 582 |
| 80 | 2000 |
| 85 | 2000 |
| 90 | 2000 |
| 94 | 2000 |

The data in Table 2 indicates that the flow rate of purified water remains high until about 50° C. at which point it begins to drop drastically (until 75° C.). Beyond this point, water pre-heated to 70° C. is supplied from the compartment (109) for storage of pre-heated water. Therefore, the flowrate increases again after going through the minima at 75° C.

1. A RO water purifier (100) comprising:
(i) an inlet for raw water comprising a pressure reducing valve (101);
(ii) a booster pump (103);
(iii) a RO membrane (102) configured to work under an operating pressure,
(iv) a device (108) for heating or cooling purified ambient water;
(v) a user-interface for dispensing hot, cold, or ambient purified water; and
(vi) a Micro Controller Unit (MCU) to control functions of said purifier,
where said purifier comprises a compartment (109) to store pre-heated or pre-cooled purified water, comprising an inlet (110) and an outlet (111),
wherein, when said purifier (100) is in use, any undispensed purified hot, cold, or ambient water returns into said compartment (109) through said inlet (110), where it remains pre-heated or pre-cooled, and when a user dispenses water through said user interface, said pre-heated or pre-cooled purified water flows out of said compartment through said outlet (111) into said device (108) for further heating or cooling it, before being dispensed, and further wherein said device (108) for heating or cooling the purified ambient water is configured to heat the water to 80 to 95° C. or alternatively, is configured to cool it to 15 to 5° C., and in said compartment (109) said pre-heated water is stored at 40 to 75° C. and when it is pre-cooled it is stored at 10 to 20° C., and said purified ambient water is at a temperature from 25 to 40° C.

2) A The purifier (100) according to claim 1 wherein said RO membrane (102) comprises an inlet (104) for water, a first outlet (105) for purified ambient water, a second outlet (106) for recirculation of excess purified ambient water back to said inlet for raw water, and a third outlet (107) leading to a device (108) for heating or cooling said purified ambient water.

3) The purifier according to claim 1 wherein said pressure reducing valve (101) reduces pressure if beyond the operating pressure of the RO membrane (102).

4) A The purifier according to claim 1 wherein said booster pump (103) increases said pressure if it is lower than said operating pressure.

5) A The water purifier according to claim 1 wherein said operating pressure is 0.5 to 1.0 MPa.

6) A The water purifier according to claim 1 wherein said compartment (109) comprises a further inlet (112) for inflow of purified ambient water from the RO membrane (102).

7) A The water purifier according to claim 1 wherein:
(a) said first outlet (105) is provided with an ambient water solenoid valve (113)
(b) said second outlet (106) is provided with a recirculation solenoid valve (114)
(c) said third outlet (107) is provided with a further solenoid valve (115); and,
(d) said further inlet (112) is provided with an ambient water solenoid valve (116).

8) A The water purifier according to claim 1 wherein said user interface comprises plurality of buttons for providing options to dispense hot, cold, or ambient purified water at temperature ranging from 5 to 95° C.
